(19) United States
(12) Patent Application Publication
(10) Pub. No.: US 2025/0215142 A1
(43) Pub. Date: Jul. 3, 2025

(54) THERMOPLASTIC POLYURETHANE RESIN AND METHOD FOR PRODUCING THE SAME

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); HAO-SHENG CHEN, TAIPEI (TW); CHEN-WEI CHANG, TAIPEI (TW)

(21) Appl. No.: 18/609,413

(22) Filed: Mar. 19, 2024

(30) Foreign Application Priority Data
Dec. 27, 2023 (TW) 112150895

(51) Int. Cl. C08G 18/48; C08G 18/10; C08G 18/76

(52) U.S. Cl. CPC C08G 18/4854; C08G 18/10; C08G 18/7671

(57) ABSTRACT

A thermoplastic polyurethane resin and method for producing the same are provided. The method includes a reacting process implemented by reacting a diphenylmethane diisocyanate, a polyether polyol, and a chain extender to form a prepolymer and a measuring and terminating process implemented by measuring a current melting index of the prepolymer and adding a chain terminator when the current melting index reaches a predetermined melting index to form a thermoplastic polyurethane resin having a melting index. The predetermined melting index is within a range from 7 g/min to 10 g/min, and the melting index is within a range from 2 g/min to 10 g/min. A ratio between a weight average molecular weight and a number average molecular weight of the thermoplastic polyurethane resin is between 1.5 and 1.75.

### CROSS-REFERENCE TO RELATED PATENT APPLICATION

This application claims the benefit of priority to Taiwan Patent Application No. 112150895, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermoplastic polyurethane resin and method for producing the same, and more particularly to a thermoplastic polyurethane resin that generates less flue gas and method for producing the same.

### BACKGROUND OF THE DISCLOSURE

When processing a conventional thermoplastic polyurethane resin, the conventional thermoplastic polyurethane resin can easily crack and generate flue gas. The flue gas generated due to cracking can cause damage to the operation environment and operator, and existing properties of the conventional thermoplastic polyurethane resin can deteriorate as a result of the cracking.

### SUMMARY OF THE DISCLOSURE

In response to the above-referenced technical inadequacy, the present disclosure provides a thermoplastic polyurethane resin and method for producing the same to effectively improve on an issue of a conventional thermoplastic polyurethane resin that easily cracks.

In order to solve the above-mentioned problems, one of the technical aspects adopted by the present disclosure is to provide a method for producing a thermoplastic polyurethane resin. The method includes a reacting process and a measuring and terminating process. The reacting process is implemented by reacting a diphenylmethane diisocyanate, a polyether polyol, and a chain extender to form a prepolymer. The polyether polyol is selected from the group consisting of a high purity polyoxytetramethylene glycol, polyoxypropylene glycol, and polyethylene glycol, and the chain extender is selected from the group consisting of 1,4-butanediol, 1,3-propanediol, diethylene glycol, and 2-methylpropanediol. The measuring and terminating process is implemented by measuring a current melting index of the prepolymer and adding a chain terminator when the current melting index reaches a predetermined melting index to form a thermoplastic polyurethane resin having a melting index. The predetermined melting index is within a range from 7 g/min to 10 g/min, and the melting index is within a range from 2 g/min to 10 g/min. A ratio between a weight average molecular weight and a number average molecular weight of the thermoplastic polyurethane resin is between 1.5 and 1.75.

In one of the possible or preferred embodiments, a content of the diphenylmethane diisocyanate is 33 parts by weight to 36 parts by weight, a content of the polyether polyol is 53 parts by weight to 57 parts by weight, a content of the chain extender is 7 parts by weight to 9 parts by weight, and a content of the chain terminator is 0.1 parts by weight to 0.3 parts by weight.

In one of the possible or preferred embodiments, the polyether polyol is the high purity polyoxytetramethylene glycol, the high purity polyoxytetramethylene glycol includes a polyoxytetramethylene glycol and an impurity, the impurity includes tetrahydrofuran and tetrahydrofuran oligomers, and a purity of the high purity polyoxytetramethylene glycol is within a range from 95% to 99.9%.

In one of the possible or preferred embodiments the chain terminator is selected from the group consisting of lauric alcohol, palmitic alcohol, and stearyl alcohol.

In one of the possible or preferred embodiments, in the reacting process, an antioxidant is further added, the antioxidant is selected from the group consisting of tetrakis [β-(3,5-di-tert-butyl-4-hydroxyphenyl) propionate]pentaerythritol, 2,6-dibutyl-p-cresol, (3,5-di-tert-butyl-4-hydroxy phenyl) octyl propionate and N,N′-bis-(3-(3,5-di-tert-butyl-4-hydroxyphenyl) propionyl) hexanediamine, and a content of the antioxidant is 0.5 parts by weight to 1 part by weight.

In one of the possible or preferred embodiments, the number average molecular weight of the thermoplastic polyurethane resin is within a range from 85,000 to 90,000.

In one of the possible or preferred embodiments, the weight average molecular weight of the thermoplastic polyurethane resin is within a range from 100,000 to 180,000.

In order to solve the above-mentioned problems, another one of the technical aspects adopted by the present disclosure is to provide a thermoplastic polyurethane resin. The thermoplastic polyurethane resin includes a diphenylmethane diisocyanate, a polyether polyol, a chain extender, and a chain terminator. The polyether polyol is selected from the group consisting of a high purity polyoxytetramethylene glycol, polyoxypropylene glycol, and polyethylene glycol. The polyether polyol is selected from the group consisting of a high purity polyoxytetramethylene glycol, polyoxypropylene glycol, and polyethylene glycol. The chain extender is selected from the group consisting of 1,4-butanediol, 1,3-propanediol, diethylene glycol, and 2-methylpropanediol. A melting index of the thermoplastic polyurethane resin is within a range from 2 g/min to 10 g/min, and a ratio between a weight average molecular weight and a number average molecular weight of the thermoplastic polyurethane resin is between 1.5 and 1.75.

In one of the possible or preferred embodiments, a content of the diphenylmethane diisocyanate is 33 parts by weight to 36 parts by weight, a content of the polyether polyol is 53 parts by weight to 57 parts by weight, a content of the chain extender is 7 parts by weight to 9 parts by weight, and a content of the chain terminator is 0.1 parts by weight to 0.3 parts by weight.

In one of the possible or preferred embodiments, the polyether polyol is the high purity polyoxytetramethylene glycol, the high purity polyoxytetramethylene glycol includes a polyoxytetramethylene glycol and an impurity, the impurity includes tetrahydrofuran and tetrahydrofuran oligomers, and a purity of the high purity polyoxytetramethylene glycol is within a range from 95% to 99.9%.

In one of the possible or preferred embodiments, the chain terminator is selected from the group consisting of lauric alcohol, palmitic alcohol, and stearyl alcohol.

In one of the possible or preferred embodiments, the thermoplastic polyurethane resin further includes an antioxidant. The antioxidant is selected from the group consisting of tetrakis [β-(3,5-di-tert-butyl-4-hydroxyphenyl) propionate]pentaerythritol, 2,6-dibutyl-p-cresol, (3,5-di-tert-butyl-4-hydroxy phenyl) octyl propionate and N,N′-bis-(3-(3,5-di-tert-butyl-4-hydroxyphenyl) propionyl) hexanediamine, and a content of the antioxidant is 0.5 parts by weight to 1 part by weight.

In one of the possible or preferred embodiments, the number average molecular weight of the thermoplastic polyurethane resin is within a range from 85,000 to 90,000.

In one of the possible or preferred embodiments, the weight average molecular weight of the thermoplastic polyurethane resin is within a range from 100,000 to 180,000.

Therefore, in the thermoplastic polyurethane resin and method for producing the same provided by the present disclosure, by virtue of “the melting index of the thermoplastic polyurethane resin being within the range from 2 g/min to 10 g/min” and “the ratio between the weight average molecular weight and the number average molecular weight of the thermoplastic polyurethane resin being between 1.5 and 1.75,” the issue of the conventional thermoplastic polyurethane resin easily cracking can be effectively improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for producing a thermoplastic polyurethane resin according to an embodiment of the present disclosure; and

FIG. 2 a gel permeation chromatography results chart of a thermoplastic polyurethane resin according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Method for Producing a Thermoplastic Polyurethane Resin

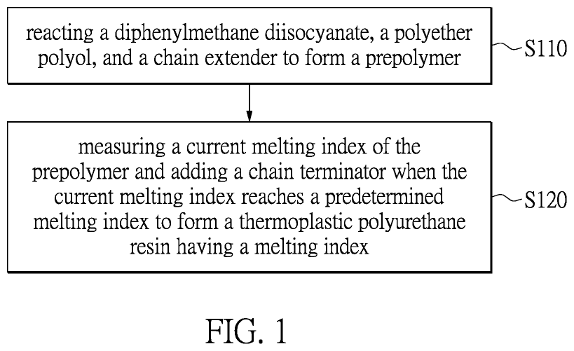

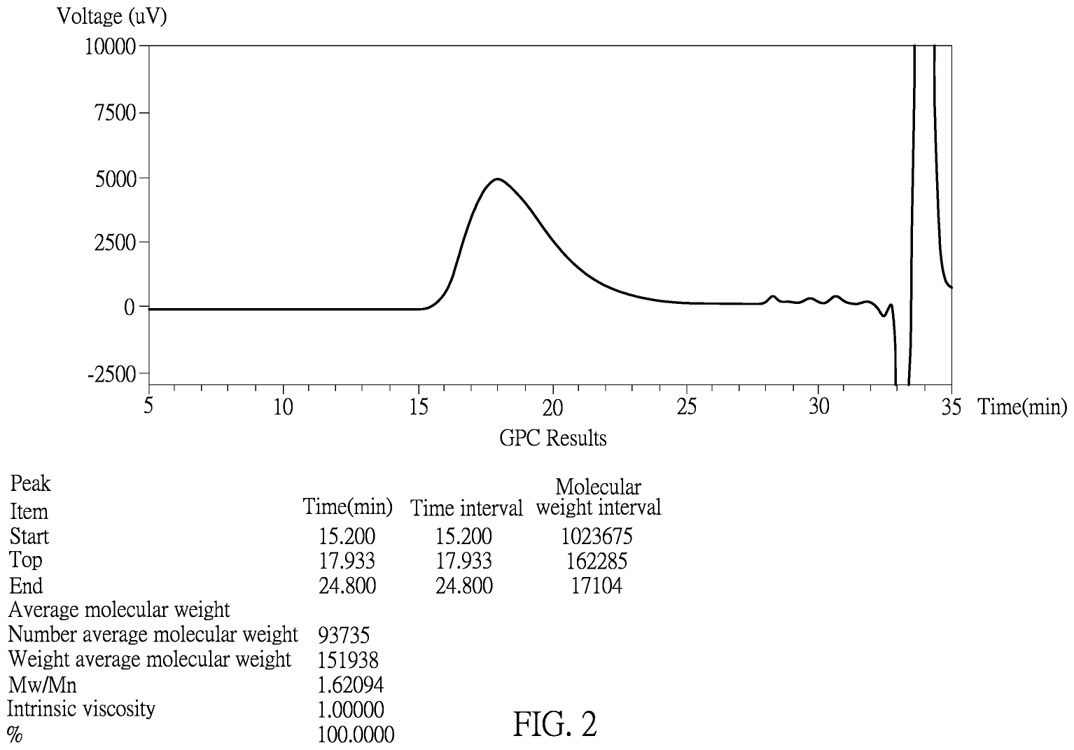

Referring to FIG. 1 and FIG. 2, FIG. 1 is a flowchart of a method for producing a thermoplastic polyurethane resin according to an embodiment of the present disclosure, and FIG. 2 a gel permeation chromatography results chart of a thermoplastic polyurethane resin according to the embodiment of the present disclosure. An embodiment of the present disclosure provides a method for producing a thermoplastic polyurethane resin. The method includes a reacting process S110 and a measuring and terminating process S120.

In the reacting process S110, a diphenylmethane diisocyanate, a polyether polyol, and a chain extender are reacted to form a prepolymer. The polyether polyol is selected from the group consisting of a high purity polyoxytetramethylene glycol, polyoxypropylene glycol, and polyethylene glycol, and the chain extender is selected from the group consisting of 1,4-butanediol, 1,3-propanediol, diethylene glycol, and 2-methylpropanediol.

In the reacting process S110, a content of the diphenylmethane diisocyanate can be 33 parts by weight to 36 parts by weight, a content of the polyether polyol can be 53 parts by weight to 57 parts by weight, and a content of the chain extender can be 7 parts by weight to 9 parts by weight.

In addition, in the reacting process S110, an antioxidant can be further added, the antioxidant is selected from the group consisting of tetrakis [β-(3,5-di-tert-butyl-4-hydroxyphenyl) propionate]pentaerythritol, 2,6-dibutyl-p-cresol, (3,5-di-tert-butyl-4-hydroxy phenyl) octyl propionate and N,N′-bis-(3-(3,5-di-tert-butyl-4-hydroxyphenyl) propionyl) hexanediamine, and a content of the antioxidant is 0.5 parts by weight to 1 part by weight.

In one embodiment, the polyether polyol can be the high purity polyoxytetramethylene glycol, the high purity polyoxytetramethylene glycol includes a polyoxytetramethylene glycol and an impurity, the impurity includes tetrahydrofuran and tetrahydrofuran oligomers, and a purity of the high purity polyoxytetramethylene glycol is within a range from 95% to 99.9%. The purity of the high purity polyoxytetramethylene glycol can be defined as a weight ratio of the polyoxytetramethylene glycol divided by the high purity polyoxytetramethylene glycol. The above-mentioned purity can be analyzed through gas chromatography.

It is worth mentioning that, since a purity of a polyoxytetramethylene glycol that is commonly available on the market is not high enough, when producing a thermoplastic polyurethane resin, excessive impurities of the polyoxytetramethylene glycol that is commonly available on the market can easily cause the generation of oligomers, and the oligomers cause the generation of flue gas in a subsequent processing (e.g., laminating) of the polyoxytetramethylene glycol. Accordingly, the purity of the high purity polyoxytetramethylene glycol in the present embodiment is between 95% and 99.9%. Preferably, the purity of the high purity polyoxytetramethylene glycol in the present embodiment is between 99.8% and 99.9%. In addition, if a polyoxytetramethylene glycol having a purity of 100% is used, an overall cost is too high.

In the measuring and terminating process S120, a current melting index of the prepolymer is measured and a chain terminator is added when the current melting index reaches a predetermined melting index to form a thermoplastic polyurethane resin having a melting index. The predetermined melting index is within a range from 7 g/min to 10 g/min, and the melting index is within a range from 2 g/min to 10 g/min. Preferably, the melting index is within a range from 3 g/min to 8 g/min, and more preferably, the melting index is within a range from 4 g/min to 7 g/min.

In the measuring and terminating process S120, through measuring the current melting index and adding the chain terminator in time, the melting index of the thermoplastic polyurethane resin can be control, so that a weight average molecular weight of the thermoplastic polyurethane resin can fall in a specific range.

Furthermore, the weight average molecular weight of the thermoplastic polyurethane resin can be within a range from 100,000 to 180,000. It is worth mentioning that, the property of the thermoplastic polyurethane resin is affected when the weight average molecular weight of the thermoplastic polyurethane resin is too high or too low. For example, if the weight average molecular weight of the thermoplastic polyurethane resin is too low (e.g., lower than 100,000), a surface of a film made of the thermoplastic polyurethane resin may be relatively rough (e.g., having rough protrusions). Conversely, if the weight average molecular weight of the thermoplastic polyurethane resin is too high (e.g., higher than 180,000), the surface of the film made of the thermoplastic polyurethane resin may have crystal points. Preferably, the weight average molecular weight of the thermoplastic polyurethane resin can be within a range from 110,000 to 160,000. More preferably, the weight average molecular weight of the thermoplastic polyurethane resin can be within a range from 130,000 to 150,000. In addition, the thermoplastic polyurethane resin has a number average molecular weight within a range from 85,000 to 90,000.

In the measuring and terminating process S120, a content of the chain terminator can be 0.1 parts by weight to 0.3 parts by weight, and the chain terminator can be selected from the group consisting of lauric alcohol, palmitic alcohol, and stearyl alcohol.

A ratio between the weight average molecular weight and the number average molecular weight of the thermoplastic polyurethane resin is between 1.5 and 1.75. Preferably, the ratio between the weight average molecular weight and the number average molecular weight of the thermoplastic polyurethane resin is between 1.6 and 1.65. More preferably, the ratio between the weight average molecular weight and the number average molecular weight of the thermoplastic polyurethane resin is about 1.62.

It is worth mention that, the ratio between the weight average molecular weight and the number average molecular weight can be regarded as a reference for understanding polymer distribution. When the ratio between the weight average molecular weight and the number average molecular weight is substantially equal to 1, it means that a molecular weight of a polymer exhibits an even distribution. When the ratio between the weight average molecular weight and the number average molecular weight slightly greater than 1 (e.g., between 1.5 and 2), it means that the distribution of the molecular weight of the polymer is relatively narrow and concentrated. When the ratio between the weight average molecular weight and the number average molecular weight far greater than 1 (e.g., between 20 and 50), it means the distribution of the molecular weight of the polymer is relatively wide and dispersed.

Since the ratio between the weight average molecular weight and the number average molecular weight of the thermoplastic polyurethane resin of the present embodiment is between 1.5 and 1.75, a molecular weight distribution of the thermoplastic polyurethane resin is relatively narrow and concentrated, and when producing the thermoplastic polyurethane resin, less oligomers are produced and accordingly, almost no flue gas is generated during the subsequent processing of the thermoplastic polyurethane resin.

### Thermoplastic Polyurethane Resin

The present disclosure further provides a thermoplastic polyurethane resin, the thermoplastic polyurethane resin can be produced by implementing the above-mentioned method, but the present disclosure is not limited thereto.

The thermoplastic polyurethane resin includes a diphenylmethane diisocyanate, a polyether polyol, a chain extender, and a chain terminator. The polyether polyol is selected from the group consisting of a high purity polyoxytetramethylene glycol, polyoxypropylene glycol, and polyethylene glycol, and the chain extender is selected from the group consisting of 1,4-butanediol, 1,3-propanediol, diethylene glycol, and 2-methylpropanediol. The chain terminator is selected from the group consisting of lauric alcohol, palmitic alcohol, and stearyl alcohol.

A content of the diphenylmethane diisocyanate is 33 parts by weight to 36 parts by weight, a content of the polyether polyol is 53 parts by weight to 57 parts by weight, a content of the chain extender is 7 parts by weight to 9 parts by weight, and a content of the chain terminator is 0.1 parts by weight to 0.3 parts by weight.

In one embodiment, the polyether polyol can be the high purity polyoxytetramethylene glycol, the high purity polyoxytetramethylene glycol includes a polyoxytetramethylene glycol and an impurity, the impurity includes tetrahydrofuran and tetrahydrofuran oligomers, and a purity of the high purity polyoxytetramethylene glycol is within a range from 95% to 99.9%.

In one embodiment, the thermoplastic polyurethane resin can further include an antioxidant, the antioxidant is selected from the group consisting of tetrakis [β-(3,5-di-tert-butyl-4-hydroxyphenyl) propionate]pentaerythritol, 2,6-dibutyl-p-cresol, (3,5-di-tert-butyl-4-hydroxy phenyl) octyl propionate and N,N′-bis-(3-(3,5-di-tert-butyl-4-hydroxyphenyl) propionyl) hexanediamine, and a content of the antioxidant is 0.5 parts by weight to 1 part by weight.

The thermoplastic polyurethane resin has a melting index within a range from 2 g/min to 10 g/min, a weight average molecular weight within a range from 100,000 to 180,000, and a number average molecular weight within a range from 85,000 to 90,000. A ratio between the weight average molecular weight and the number average molecular weight of the thermoplastic polyurethane resin is between 1.5 and 1.75.

### Experimental Results

Hereinafter, a more detailed description will be provided with reference to Exemplary Examples 1 to 4 and Comparative Examples 1 to 3. However, the following Exemplary Examples are only used to aid in understanding of the present disclosure, and are not to be construed as limiting the scope of the present disclosure.

In Exemplary Example 1, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 0.5 parts by weight of antioxidant, and 1 part by weight of chain terminator, and a purity of the high purity polyoxytetramethylene glycol is 99.8%.

In Exemplary Example 2, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 1 part by weight of antioxidant, and 0.2 parts by weight of chain terminator, and a purity of the high purity polyoxytetramethylene glycol is 99.8%.

In Exemplary Example 3, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 1 part by weight of antioxidant, and 0.2 parts by weight of chain terminator, and a purity of the high purity polyoxytetramethylene glycol is 99.9%.

In Exemplary Example 4, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 1 part by weight of antioxidant, and 0.3 parts by weight of chain terminator, and a purity of the high purity polyoxytetramethylene glycol is 99.8%.

In Comparative Example 1, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 0 part by weight of antioxidant, and 0.2 parts by weight of chain terminator, and a purity of the high purity polyoxytetramethylene glycol is 99.8%.

In Comparative Example 2, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 1 part by weight of antioxidant, and 0 part by weight of chain terminator, and a purity of the high purity polyoxytetramethylene glycol is 99.9%.

In Comparative Example 3, the thermoplastic polyurethane resin includes 34.7 parts by weight of diphenylmethane diisocyanate, 55.5 parts by weight of polyether polyol (i.e., high purity polyoxytetramethylene glycol), 8.2 parts by weight of chain extender, 1 part by weight of antioxidant, and 0.2 parts by weight of chain terminator, and a purity of the high purity polyoxytetramethylene glycol is 99.5%.

For the thermoplastic polyurethane resin of each of Exemplary Examples 1 to 4 and Comparative Examples 1 to 3, components, melting index, weight average molecular weight, number average molecular weight, amount of flue gas, initial yellowness index (i.e., YI) value, film appearance, and purity of the high purity polyoxytetramethylene glycol are listed in Table 1 below. The relevant test methods are also described as follows.

A melting index test is carried out according to the ASTM D1238 standard.

A weight average molecular weight and number average molecular weight test is carried out by using a gel permeation chromatography analyzer to analyze the weight average molecular weight and the number average molecular weight of the thermoplastic polyurethane resin.

A flue gas amount test is carried out by placing 30 g of the thermoplastic polyurethane resin on a round plate and comparing the generation of the flue gas with a moisture heating analyzer (Model HX204) after heating to 220° C. for 30 minutes.

An initial yellowness index value test is carried out by using a spectrophotometer (Model X-rite Color-Eye 70000A) to test an initial yellowness index of the thermoplastic polyurethane resin.

TABLE 1
[Components of Exemplary Examples and Comparative Examples and Test Results of Physical and Chemical Properties]

| | | Exemplary | Exemplary | Exemplary | Exemplary | Comparative | Comparative | Comparative |
|---|---|---|---|---|---|---|---|---|
| | Item | example 1 | example 2 | example 3 | example 4 | example 1 | example 2 | example 3 |
| Parameter | Content of | 34.7 | 34.7 | 34.7 | 34.7 | 34.7 | 34.7 | 34.7 |
| of each | diphenylmethane | | | | | | | |
| component | diisocyanate | | | | | | | |
| | (parts by weight) | | | | | | | |
| | Content of | 55.5 | 55.5 | 55.5 | 55.5 | 55.5 | 55.5 | 55.5 |
| | polyether polyol | | | | | | | |
| | (parts by weight) | | | | | | | |
| | Content of | 8.2 | 8.2 | 8.2 | 8.2 | 8.2 | 8.2 | 8.2 |
| | chain extender | | | | | | | |
| | (parts by weight) | | | | | | | |
| | Content of | 0.5 | 1.0 | 1.0 | 1.0 | 0 | 1.0 | 1.0 |
| | antioxidant | | | | | | | |
| | (parts by weight) | | | | | | | |
| | Content of chain | 0.1 | 0.2 | 0.2 | 0.3 | 0.2 | 0 | 0.2 |
| | terminator | | | | | | | |
| | (parts by weight) | | | | | | | |
| | Purity of high | 99.8 | 99.8 | 99.9 | 99.8 | 99.9 | 99.9 | 99.5 |
| | purity polyoxytetra- | | | | | | | |
| | methylene glycol, | | | | | | | |
| | polyoxypropylene | | | | | | | |
| | glycol (%) | | | | | | | |
| Physical | Melting index | 6.9 | 5.9 | 5.7 | 4.8 | 5.4 | 2.9 | 5.1 |
| properties | of thermoplastic | | | | | | | |
| | polyurethane resin | | | | | | | |
| | Weight average | 155,475 | 146,478 | 144,256 | 139,519 | 150,315 | 184,156 | 140,587 |
| | molecular weight of | | | | | | | |
| | thermoplastic | | | | | | | |
| | polyurethane resin | | | | | | | |
| | Number average | 89,102 | 87,711 | 85,866 | 83,544 | 88,514 | 98,145 | 86,254 |
| | molecular weight of | | | | | | | |
| | thermoplastic | | | | | | | |
| | polyurethane resin | | | | | | | |
| | Amount of flue | 0.29 | 0.21 | 0.12 | 0.20 | 0.6 | 0.17 | 0.85 |
| | gas of thermoplastic | | | | | | | |
| | polyurethane resin | | | | | | | |
| | Initial yellowness | 51.3 | 44.9 | 40.8 | 45.3 | 62.1 | 55.8 | 62.4 |
| | index value of | | | | | | | |
| | thermoplastic | | | | | | | |
| | polyurethane resin | | | | | | | |
| | Film appearance of | no | no | no | no | no | Rough | no |
| | thermoplastic | crystal | crystal | crystal | crystal | crystal | protrusions | crystal |
| | polyurethane resin | points | points | points | points | points | | points |

### Discussion of Test Results

As shown in Exemplary Examples 1 to 4, since the high heat resistance antioxidant and the chain terminator are added, a film made of the thermoplastic polyurethane resin does not have crystal points, has excellent heat resistance, and an obviously low amount of flue gas. As shown in Comparative Example 2, since no chain terminator is added, the thermoplastic polyurethane resin has relative low melting index and high molecular weight, and rough protrusions easily form.

The thermoplastic polyurethane resin of Exemplary Example 3 has low initial yellowness index value, low amount of flue gas, and do not have crystal points or rough protrusions at the appearance thereof, thereby meeting the requirements in quality.

### Beneficial Effects of the Embodiment

In conclusion, in the thermoplastic polyurethane resin and method for producing the same provided by the present disclosure, by virtue of “the melting index of the thermoplastic polyurethane resin being within the range from 2 g/min to 10 g/min” and “the ratio between the weight average molecular weight and the number average molecular weight of the thermoplastic polyurethane resin being between 1.5 and 1.75,” the issue of the conventional thermoplastic polyurethane resin easily cracking can be effectively improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a thermoplastic polyurethane resin, comprising:
a reacting process implemented by reacting a diphenylmethane diisocyanate, a polyether polyol, and a chain extender to form a prepolymer, wherein the polyether polyol is selected from the group consisting of a high purity polyoxytetramethylene glycol, polyoxypropylene glycol, and polyethylene glycol, and the chain extender is selected from the group consisting of 1,4-butanediol, 1,3-propanediol, diethylene glycol, and 2-methylpropanediol; and
a measuring and terminating process implemented by measuring a current melting index of the prepolymer and adding a chain terminator when the current melting index reaches a predetermined melting index to form a thermoplastic polyurethane resin having a melting index,
wherein the predetermined melting index is within a range from 7 g/min to 10 g/min, and the melting index is within a range from 2 g/min to 10 g/min,
wherein a ratio between a weight average molecular weight and a number average molecular weight of the thermoplastic polyurethane resin is between 1.5 and 1.75.

2. The method according to claim 1, wherein a content of the diphenylmethane diisocyanate is 33 parts by weight to 36 parts by weight, a content of the polyether polyol is 53 parts by weight to 57 parts by weight, a content of the chain extender is 7 parts by weight to 9 parts by weight, and a content of the chain terminator is 0.1 parts by weight to 0.3 parts by weight.

3. The method according to claim 1, wherein the polyether polyol is the high purity polyoxytetramethylene glycol, the high purity polyoxytetramethylene glycol includes a polyoxytetramethylene glycol and an impurity, the impurity includes tetrahydrofuran and tetrahydrofuran oligomers, and a purity of the high purity polyoxytetramethylene glycol is within a range from 95% to 99.9%.

4. The method according to claim 1, wherein the chain terminator is selected from the group consisting of lauric alcohol, palmitic alcohol, and stearyl alcohol.

5. The method according to claim 1, wherein, in the reacting process, an antioxidant is further added, the antioxidant is selected from the group consisting of tetrakis [β-(3,5-di-tert-butyl-4-hydroxyphenyl) propionate]pentaerythritol, 2,6-dibutyl-p-cresol, (3,5-di-tert-butyl-4-hydroxy phenyl) octyl propionate and N,N′-bis-(3-(3,5-di-tert-butyl-4-hydroxyphenyl) propionyl) hexanediamine, and a content of the antioxidant is 0.5 parts by weight to 1 part by weight.

6. The method according to claim 1, wherein the number average molecular weight of the thermoplastic polyurethane resin is within a range from 85,000 to 90,000.

7. The method according to claim 1, wherein the weight average molecular weight of the thermoplastic polyurethane resin is within a range from 100,000 to 180,000.

8. A thermoplastic polyurethane resin, comprising:
a diphenylmethane diisocyanate, wherein the polyether polyol is selected from the group consisting of a high purity polyoxytetramethylene glycol, polyoxypropylene glycol, and polyethylene glycol;
a polyether polyol, the polyether polyol is selected from the group consisting of a high purity polyoxytetramethylene glycol, polyoxypropylene glycol, and polyethylene glycol;
a chain extender, the chain extender is selected from the group consisting of 1,4-butanediol, 1,3-propanediol, diethylene glycol, and 2-methylpropanediol; and
a chain terminator;
wherein a melting index of the thermoplastic polyurethane resin is within a range from 2 g/min to 10 g/min, and a ratio between a weight average molecular weight and a number average molecular weight of the thermoplastic polyurethane resin is between 1.5 and 1.75.

9. The thermoplastic polyurethane resin according to claim 8, wherein a content of the diphenylmethane diisocyanate is 33 parts by weight to 36 parts by weight, a content of the polyether polyol is 53 parts by weight to 57 parts by weight, a content of the chain extender is 7 parts by weight to 9 parts by weight, and a content of the chain terminator is 0.1 parts by weight to 0.3 parts by weight.

10. The thermoplastic polyurethane resin according to claim 8, wherein the polyether polyol is the high purity polyoxytetramethylene glycol, the high purity polyoxytetramethylene glycol includes a polyoxytetramethylene glycol and an impurity, the impurity includes tetrahydrofuran and tetrahydrofuran oligomers, and a purity of the high purity polyoxytetramethylene glycol is within a range from 95% to 99.9%.

11. The thermoplastic polyurethane resin according to claim 8, wherein the chain terminator is selected from the group consisting of lauric alcohol, palmitic alcohol, and stearyl alcohol.

12. The thermoplastic polyurethane resin according to claim 8, further comprising an antioxidant, wherein the antioxidant is selected from the group consisting of tetrakis [β-(3,5-di-tert-butyl-4-hydroxyphenyl) propionate]pentaerythritol, 2,6-dibutyl-p-cresol, (3,5-di-tert-butyl-4-hydroxy phenyl) octyl propionate and N,N′-bis-(3-(3,5-di-tert-butyl-4-hydroxyphenyl) propionyl) hexanediamine, and a content of the antioxidant is 0.5 parts by weight to 1 part by weight.

13. The thermoplastic polyurethane resin according to claim 8, wherein the number average molecular weight of the thermoplastic polyurethane resin is within a range from 85,000 to 90,000.

14. The thermoplastic polyurethane resin according to claim 8, wherein the weight average molecular weight of the thermoplastic polyurethane resin is within a range from 100,000 to 180,000.
